(19) United States
(12) Patent Application Publication
(10) Pub. No.: US 2011/0113631 A1
(43) Pub. Date: May 19, 2011

(54) Apparatus and Method of Holding Razors

(76) Inventor: Edward A. Zdunek, Crystal Lake, IL (US)

(21) Appl. No.: 12/877,546

(22) Filed: Sep. 8, 2010

Related U.S. Application Data
(60) Provisional application No. 61/262,363, filed on Nov. 18, 2009.

(51) Int. Cl. B26B 19/00; A41D 19/00

(52) U.S. Cl. 30/34.05; 2/160

(57) ABSTRACT

A razor holder for use with a plurality of razor elements includes a hand wearable article configured to fit over a hand of a user. The hand wearable article includes a body portion having a palmar side and a dorsal side, the body portion further defining a cuff opening, four finger stalls extending from the body portion, each finger stall including a finger tip portion and a finger strap configured to gather excess finger stall material, and a thumb stall extending from the body portion and including a thumb tip portion and a thumb strap configured to gather excess thumb stall material. A primary razor retainer is coupled to each of the finger tip portions of the four finger stalls and the thumb tip portion of the thumb stall, each primary razor retainer being configured to secure a razor element. An auxiliary razor retainer is coupled to each of the finger tip portions of the four finger stalls and the thumb tip portion of the thumb stall, each auxiliary razor retainer being configured to secure a razor element. A palm shield is coupled to the palmar side of the body portion and formed of a cut resistant material, the palm shield including razor receptacles sized to releasably receive the plurality of razor elements.

### CROSS-REFERENCE TO RELATED APPLICATION

This application claims the benefit of U.S. Provisional Application Ser. No. 61/262,363, filed on Nov. 18, 2009, which is incorporated herein by reference.

### BACKGROUND

1. Technical Field

This disclosure generally relates to shaving razors, and more particularly to apparatus and methods of holding razors during use.

2. Description of the Related Art

Shaving razors, including disposable and cartridge razors, are well known in the art. Such conventional devices typically include a razor head coupled to an elongated handle. The user grasps the handle to manipulate the razor head during use. Such handles, however, are often difficult to grasp and can be awkward to position properly, especially when shaving legs or other hard to reach areas.

Finger-mounted razors have been proposed as an alternative to handle-mounted razors. Finger-mounted razors generally include a razor head mounted on a base. The base, in turn, is coupled to an attachment device that is configured to be placed on one or more fingers of the user. While such finger-mounted may provide the user better control and feel during use, they are typically limited to a single razor element. Additionally, it may be overly difficult to determine how to mount the attachment device on the finger(s), let alone actually mounting the device in the proper location on the finger(s).

### SUMMARY OF THE DISCLOSURE

According to some embodiments, a razor holder is provided for use with a plurality of razor elements. The razor holder may include a hand wearable article configured to fit over a hand of a user, the hand wearable article including a body portion having a palmar side and a dorsal side, the body portion further defining a cuff opening, and at least two finger stalls extending from the body portion. A primary razor retainer is coupled to each of the at least two finger stalls, each primary razor retainer being configured to secure a razor element.

According to additional embodiments, a razor holder is provided for use with a plurality of razor elements that includes a hand wearable article configured to fit over a hand of a user, the hand wearable article having a body portion with a palmar side and a dorsal side, the body portion further defining a cuff opening, four finger stalls extending from the body portion, and a thumb stall extending from the body portion. A primary razor retainer is coupled to each of the four finger stalls and the thumb stall, each primary razor retainer being configured to secure a razor element.

According to further embodiments, a razor holder is provided for use with a plurality of razor elements that includes a hand wearable article configured to fit over a hand of a user. The hand wearable article includes a body portion having a palmar side and a dorsal side, the body portion further defining a cuff opening, four finger stalls extending from the body portion, each finger stall including a finger tip portion and a finger strap configured to gather excess finger stall material, and a thumb stall extending from the body portion and including a thumb tip portion and a thumb strap configured to gather excess thumb stall material. A primary razor retainer is coupled to each of the finger tip portions of the four finger stalls and the thumb tip portion of the thumb stall, each primary razor retainer being configured to secure a razor element. An auxiliary razor retainer is coupled to each of the finger tip portions of the four finger stalls and the thumb tip portion of the thumb stall, each auxiliary razor retainer being configured to secure a razor element. A palm shield is coupled to the palmar side of the body portion and formed of a cut resistant material, the palm shield including razor receptacles sized to releasably receive the plurality of razor elements.

### BRIEF DESCRIPTION OF THE DRAWINGS

For a more complete understanding of the disclosed methods and apparatuses, reference should be made to the embodiment illustrated in greater detail on the accompanying drawings, wherein:

FIG. 1 is a plan view of a palmar side of a razor holder constructed according to the present disclosure;

FIG. 2 is a plan view of a dorsal side of a razor holder constructed according to the present disclosure;

FIG. 3 is a side elevation view, in cross-section, of a razor retainer and razor head attached to the razor holder of FIG. 1;

FIG. 4 is a side elevation view of an alternative razor retainer providing multiple attachment points for the razor head; and

FIG. 5 is a side elevation view of another alternative razor retainer usable with the razor holder of FIG. 1.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

A holder is provided as hand wearable article adapted to carry a plurality of razor heads. The hand wearable article may be provided in the form of a glove having a body portion and at least two finger stalls. By providing the holder in the form of a glove, a user intuitively understands how to position the holder on the hand. A razor head may be attached to each finger stall, thereby providing a holder for multiple razor heads that may be manipulated independently of each other. The ability to use multiple razor heads simultaneously reduces the amount of time needed to shave the intended area. Additionally, with each razor head being mounted on a separate finger, the user may manipulate the razor heads more accurately

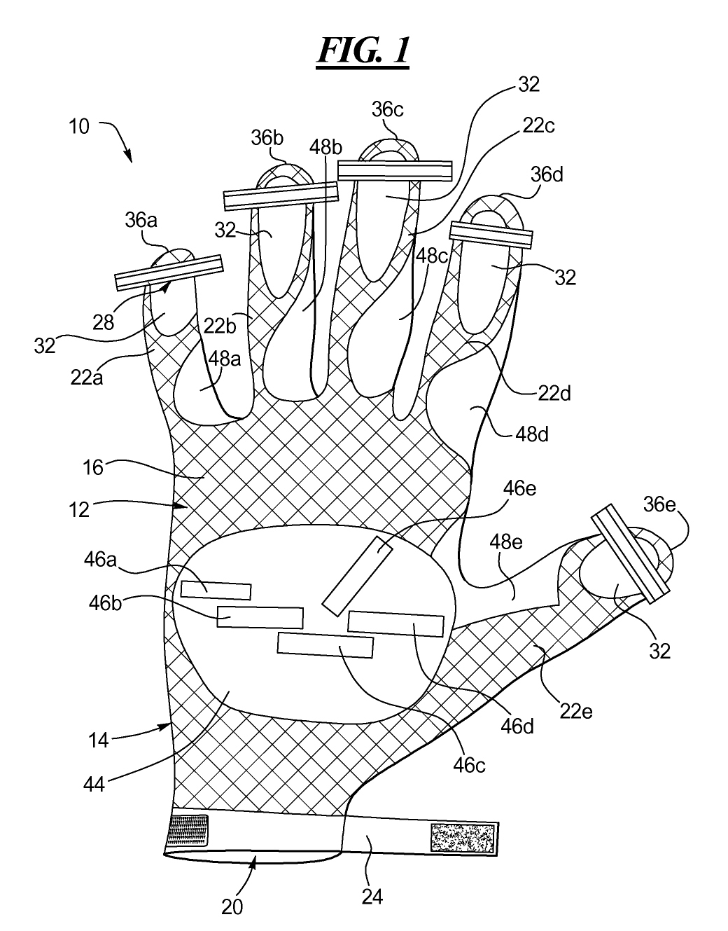

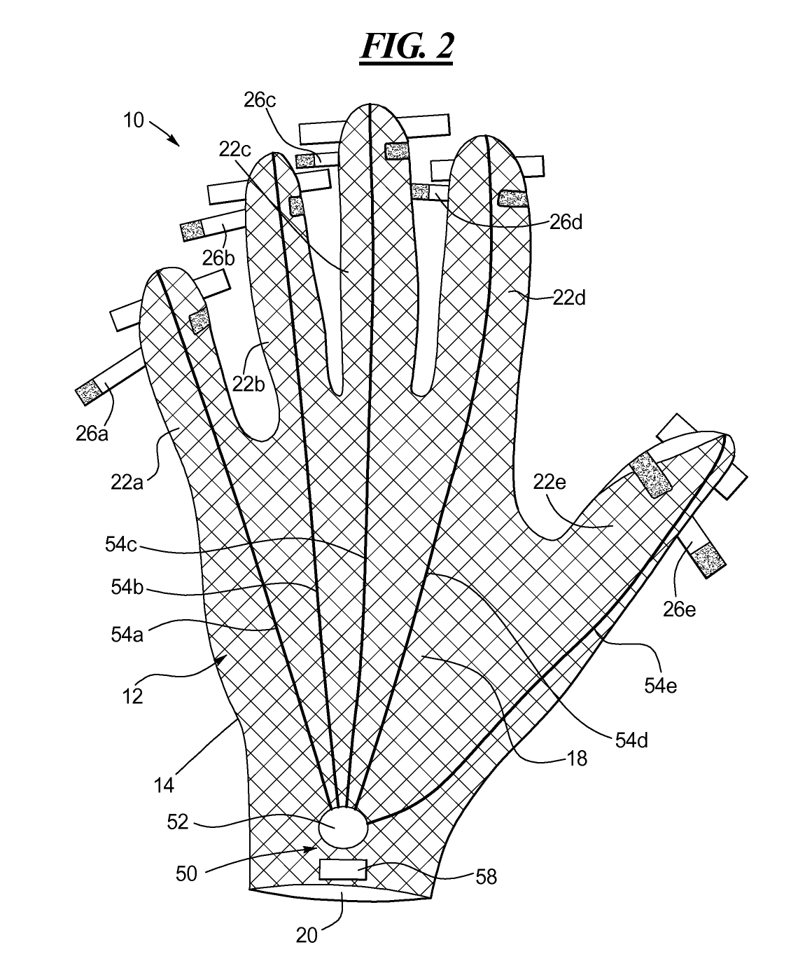

FIGS. 1 and 2 illustrate a razor holder 10 that includes a hand wearable article, such as a glove 12. The glove 12 is configured to fit over a hand of a user. In the illustrated embodiment, the glove 12 includes a body portion 14 that includes a palmar side 16 (FIG. 1) and a dorsal side 18 (FIG. 2). The palmar side 16 and dorsal side 18 may be unitary or may be formed of separate panels that are joined together. The body portion 14 defines a cuff opening 20 through which the hand of the user passes when inserting or removing the glove 12. The glove 12 further includes multiple finger stalls for receiving the fingers of a user. In the illustrated embodiment, the glove 12 includes four finger stalls 22a-d and a thumb stall 22e. As will be understood more fully below, the glove 12 includes at least two finger stalls. Additionally, the glove 12 may include a second thumb stall (not shown) to provide an ambidextrous glove that may be worn on either hand. While the illustrated glove shows finger stalls 22 that are unitary with the body portion 14, in an alternative embodiment the finger stalls 22 may be removably attached to the body portion 14. As a further alternative, the rear side of each finger stall 22 may include an access opening (not shown) positioned near where the user's knuckle is located to permit the associated finger stall 22 to be removed from the user's finger while permitting the rest of the glove 12 and finger stalls to remain in place, thereby selectively removing a finger stall from use. The glove 12 may be formed of a glove material that is waterproof, water-resistant, or conventional cloth. The glove material further may have solid or mesh construction.

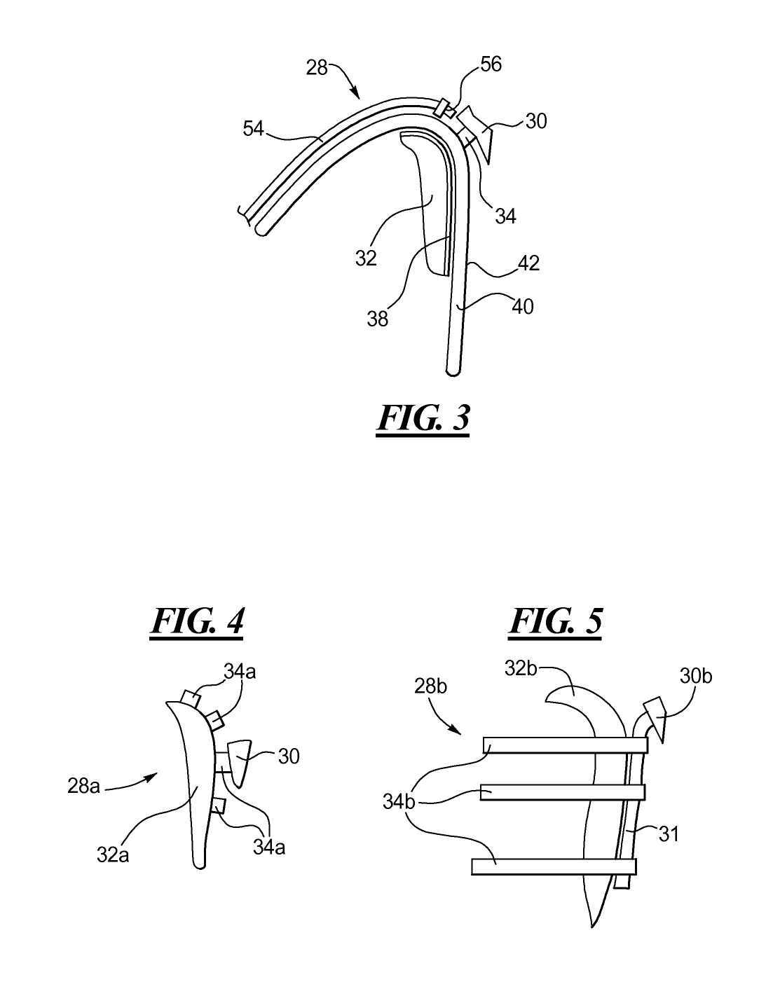

Various structures may be provided to improve the fit of the glove 12 on the user's hand. For example, a wrist strap 24 may extend around the cuff opening 20 that is securable in multiple positions, thereby to adjust the size of the cuff opening 20. Additionally or alternatively, each finger stall 22 may include means for gathering excess finger stall material, such as finger straps 26a-e (FIG. 3). The wrist strap 24 and finger straps 26a-e may be self fastenable, such as by providing a hook layer on one end of the strap and a loop layer on the other end of the strap to form a hook-and-loop fastener. The wrist strap 24 and finger straps 26a-e allow the glove 12 to more closely conform to the user's hand.

While the illustrated embodiment shows straps having hook-and-loop fasteners to improve fit, other alternative means may be used. For example, tightening lines (not shown) may be provided having one end attached to the exterior rear side of an associated finger stall 22a-e and an opposite end operatively coupled to a ratchet device (not shown), wherein the ratchet device may be manipulated to adjust glove fit. Still further, the interior rear side of each finger stall may include an expandable pocket (pocket) that fluidly communicates with an air pump (not shown), wherein the air pump may inflate the pockets thereby to pull tight the front side of each finger stall 22a-e.

Razor retainers 28 may be attached to the glove 12 and configured to secure a razor element 30. As best shown in FIG. 3, the razor retainer 28 may include a base 32 coupled to the glove 12 and a connector 34 adapted to releasably secure a razor element 30. The base 32 may be positioned near a tip 36a-e (FIG. 1) of each finger/thumb stall 22a-e and may be shaped to conform to a respective finger of the user. The base 32 may be formed of a rigid or semi-rigid material, such as plastic. The connector 34 may be releasably attached to the base 32 to permit adjustment to a particular user's finger. For example, as best shown in FIG. 3, a layer of hook material 38 may be attached to and facing outward from the base 32, while a layer of loop material 40 may have a backing surface 42 coupled to the connector 34. The connector 34 and layer of loop material 40 may be adjustably secured to the hook material 38 such that the connector 34 is disposed in the desired location.

In an alternative embodiment illustrated in FIG. 4, a razor retainer 28a includes a base 32a coupled to the glove 12. Multiple connectors 34a are attached to the base 32a. A razor element 30 may be attached to a selected one of the multiple connectors 34a, thereby to position the razor element 30 as desired.

In yet another alternative embodiment illustrated in FIG. 5, a razor retainer 28b includes a base 32b coupled to the glove 12. A plurality of connectors in the form of straps 34b may extend around the base 32b and a handle 31 of a razor element 30b, thereby to secure the razor element 30b to the glove 12.

The razor elements 30 may be provided in any known form. For example, the razor elements 30 may be conventional, replaceable razor heads. The razor elements 30 may include one, two, three, or more blades, as is generally known in the art. Furthermore, razor elements 30 having different sizes, such as different widths, may be used with the glove 12, allowing the glove 12 to be customized for specific shaving applications.

The palmar side 16 of the glove 12 may further include a palm shield 44 for reducing the risk of cuts to the user. The palm shield 44 is positioned in a central portion of the palmar side 16 and may be formed of a cut-resistant material, such as a hard plastic. Additionally or alternatively, the palm shield material may be water resistant. The palm shield 44 may further be formed with razor receptacles 46 configured to releasably receive associated razor elements 30. In the illustrated embodiment, the palm shield 44 includes five razor receptacles 46a-e positioned and oriented to receive razor elements 30 attached to the finger stalls 22a-e, so that the glove 12 may be placed in a store position with the finger stalls 22a-e bent and the razor elements 30 secured in the razor receptacles 46a-e.

To further protect the user from cuts, the finger stalls 22a-e may include finger shields 48a-e formed of a cut-resistant material such as hard plastic. The finger shields 48a-e may protect the user from one of the razor elements 30, and particularly the razor element coupled to the thumb stall 22e, from slicing through the glove 12 and injuring the user.

The glove 12 may further include a fluid dispensing assembly 50 for discharging a fluid near the razor elements 30, thereby to improve the shaving experience. As best shown in FIG. 2, the fluid dispensing assembly 50 includes a fluid source 52. Each of fluid conduits 54a-e includes a first end fluidly communicating with the fluid source 52 and a second end positioned adjacent an associated razor retainer 28. A dispenser tip 56 (FIG. 3) is secured near each razor retainer 28 and fluidly coupled to the second end of a respective fluid conduit 54a-e. An actuator, such as hand pump 58, is provided to advance fluid through the fluid conduits 54a-e and ultimately to discharge from the dispenser tips 56. Alternatively, the actuator may be positioned near a razor retainer 28 so that it engages the user's skin during shaving, thereby to automatically discharge fluid during use. The fluid may be any fluid used in conjunction with shaving, such as a lubricant, oil, or gel. The fluid source 52 may be refillable or replaceable.

The above-described embodiments of the razor holder 10 permit a user to more efficiently and safely execute a variety of shaving applications. By providing the razor elements 30 on a glove 12, the user intuitively understands how to use the razor holder 10. Additionally, the razor holder 10 allows multiple razor elements 30, possibly of different widths, to be used simultaneously. By attaching the razor elements 30 to individual fingers, each razor element 30 may be maneuvered and oriented independent of the others, thereby facilitating efficient shaving of complex skin surfaces. The number of razor elements 30 used in a shaving application may be quickly and efficiently adjusted by either placing one or more finger stalls 22a-e in the stored position or removing the razor element 30 from selected razor retainers 28.

All references, including publications, patent applications, and patents, cited herein are hereby incorporated by reference. The description of certain embodiments as “preferred” embodiments, and other recitation of embodiments, features, or ranges as being preferred, is not deemed to be limiting, and the claims are deemed to encompass embodiments that may presently be considered to be less preferred. All methods described herein can be performed in any suitable order unless otherwise indicated herein or otherwise clearly contradicted by context. The use of any and all examples, or exemplary language (e.g., “such as”) provided herein, is intended to illuminate the disclosed subject matter and does not pose a limitation on the scope of the claims. Any statement herein as to the nature or benefits of the exemplary embodiments is not intended to be limiting, and the appended claims should not be deemed to be limited by such statements. More generally, no language in the specification should be construed as indicating any non-claimed element as being essential to the practice of the claimed subject matter. The scope of the claims includes all modifications and equivalents of the subject matter recited therein as permitted by applicable law. Moreover, any combination of the above-described elements in all possible variations thereof is encompassed by the claims unless otherwise indicated herein or otherwise clearly contradicted by context. The description herein of any reference or patent, even if identified as “prior,” is not intended to constitute a concession that such reference or patent is available as prior art against the present disclosure.

What is claimed is:

1. A razor holder for use with a plurality of razor elements, the razor holder comprising:
a hand wearable article configured to fit over a hand of a user, the hand wearable article including:
a body portion having a palmar side and a dorsal side, the body portion further defining a cuff opening; and
at least two finger stalls extending from the body portion;
a primary razor retainer coupled to each of the at least two finger stalls, each primary razor retainer being configured to secure a razor element.

2. The razor holder of claim 1, in which the hand wearable article includes four finger stalls and a first thumb stall positioned on a first side of the four finger stalls.

3. The razor holder of claim 2, further comprising a primary razor retainer coupled to each of the four finger stalls and the first thumb stall.

4. The razor holder of claim 1, in which each finger stall includes a tip portion, and in which each primary razor retainer is coupled to the tip portion of each finger stall.

5. The razor holder of claim 1, in which the hand wearable article is formed of a water-resistant material.

6. The razor holder of claim 1, further comprising an auxiliary razor retainer coupled to each finger stall, each auxiliary razor retainer being configured to secure one of the plurality of razor elements.

7. The razor holder of claim 1, in which the hand wearable article further includes a wrist strap extending around the cuff opening.

8. The razor holder of claim 1, in which each finger stall further includes means for gathering excess finger stall material.

9. The razor holder of claim 8, in which the gathering means comprises a finger strap extending around the finger stall.

10. The razor holder of claim 1, further comprising a palm shield coupled to the palmar side.

11. The razor holder of claim 10, in which the palm shield is formed of a cut resistant material.

12. The razor holder of claim 10, in which the palm shield includes razor receptacles sized to releasably receive the plurality of razor elements.

13. The razor holder of claim 1, in which at least a portion of each finger stall is formed of a cut resistant material.

14. The razor holder of claim 1, further comprising a dispenser tip positioned adjacent each razor retainer, each dispenser tip fluidly communicating with a source of shaving liquid.

15. The razor holder of claim 14, further comprising an actuator operatively coupled to the source of shaving liquid for selectively releasing shaving fluid through the dispenser tip.

16. A razor holder for use with a plurality of razor elements, the razor holder comprising:
a hand wearable article configured to fit over a hand of a user, the hand wearable article including:
a body portion having a palmar side and a dorsal side, the body portion further defining a cuff opening;
four finger stalls extending from the body portion; and
a thumb stall extending from the body portion; and
a primary razor retainer coupled to each of the four finger stalls and the thumb stall, each primary razor retainer being configured to secure a razor element.

17. The razor holder of claim 16, further comprising an auxiliary razor retainer coupled to each finger stall, each auxiliary razor retainer being configured to secure one of the plurality of razor elements.

18. The razor holder of claim 16, further comprising a palm shield coupled to the palmar side and formed of a cut resistant material, the palm shield including razor receptacles sized to releasably receive the plurality of razor elements.

19. The razor holder of claim 16, in which at least a portion of each finger stall is formed of a cut resistant material.

20. A razor holder for use with a plurality of razor elements, the razor holder comprising:
a hand wearable article configured to fit over a hand of a user, the hand wearable article including:
a body portion having a palmar side and a dorsal side, the body portion further defining a cuff opening;
four finger stalls extending from the body portion, each finger stall including a finger tip portion and a finger strap configured to gather excess finger stall material; and
a thumb stall extending from the body portion and including a thumb tip portion and a thumb strap configured to gather excess thumb stall material;
a primary razor retainer coupled to each of the finger tip portions of the four finger stalls and the thumb tip portion of the thumb stall, each primary razor retainer being configured to secure a razor element;
an auxiliary razor retainer coupled to each of the finger tip portions of the four finger stalls and the thumb tip portion of the thumb stall, each auxiliary razor retainer being configured to secure a razor element; and
a palm shield coupled to the palmar side of the body portion and formed of a cut resistant material, the palm shield including razor receptacles sized to releasably receive the plurality of razor elements.
